(19) United States
(12) Patent Application Publication
(10) Pub. No.: US 2026/0058065 A1
(43) Pub. Date: Feb. 26, 2026

(54) MULTILAYER ELECTRONIC COMPONENT

(71) Applicant: SAMSUNG ELECTRO-MECHANICS CO., LTD., Suwon-si (KR)

(72) Inventors: Yong PARK, Suwon-si (KR); Kwan Soo PARK, Suwon-si (KR); Chang Ho SEO, Suwon-si (KR); Hyun Sik CHAE, Suwon-si (KR); Sun Mi KIM, Suwon-si (KR); Eun Jung LEE, Suwon-si (KR); Jong Ho LEE, Suwon-si (KR)

(73) Assignee: SAMSUNG ELECTRO-MECHANICS CO., LTD., Suwon-si (KR)

(21) Appl. No.: 19/076,076

(22) Filed: Mar. 11, 2025

(30) Foreign Application Priority Data
Aug. 23, 2024 (KR) 10-2024-0113811

(51) Int. Cl. H01G 4/30; H01G 4/232

(52) U.S. Cl. CPC H01G 4/30; H01G 4/232

(57) ABSTRACT

A multilayer electronic component includes a body including a capacitance formation portion including a dielectric layer and internal electrodes alternately arranged in a first direction and cover portions disposed on the capacitance formation portion in the first direction, first to sixth surfaces; external electrodes disposed on the third and fourth surfaces; side margin portions disposed on the fifth and sixth surfaces; and a first extension portion disposed to extend to portions of the first and second surfaces, and wherein at least a partial region of the first extension portion has a curvature, wherein when an average thickness of the side margin portion is WM0 and a radius of curvature of at least a portion of the first extension portion is R, WM0 and R may satisfy 1.1<R/WM0<2.

### CROSS-REFERENCE TO RELATED APPLICATION(S)

This application claims benefit of priority to Korean Patent Application No. 10-2024-0113811 filed on Aug. 23, 2024, in the Korean Intellectual Property Office, the disclosure of which is incorporated herein by reference in its entirety.

### TECHNICAL FIELD

The present disclosure relates to a multilayer electronic component.

Multilayer ceramic capacitors (MLCC), one type of multilayer electronic components, are chip-shaped capacitors mounted on the printed circuit boards of various electronic products such as a Liquid Crystal Display (LCD) or a Plasma Display Panel (PDP), a computer, a smartphone, and a mobile phone to charge or discharge electricity therein or therefrom.

The multilayer ceramic capacitor may be used as a component in various electronic devices due to having a small size, ensuring high capacitance and being easily mounted. With the miniaturization and implementation of high output power of various electronic devices such as computers and mobile devices, demand for miniaturization and high capacitance of multilayer ceramic capacitors has also been increasing.

In order to miniaturize and increase the capacitance of a multilayer ceramic capacitor, maximization of an effective electrode area (increasing the effective volume fraction required to realize capacity) is required. When manufacturing multilayer ceramic capacitors to implement small and high-capacitance multilayer ceramic capacitors, the internal electrodes may be manufactured to be exposed in a width direction of the body, thereby maximizing a width direction area of the internal electrode through a marginless design. In this case, a method of separately attaching a ceramic green sheet for a side margin portion to an exposure surface of the internal electrode in a width direction and then sintering the ceramic green sheet to block exposure to the outside is applied.

The side margin portion may be formed by separately attaching the ceramic green sheet for the side margin portion to improve the capacitance per unit volume of the capacitor, but problems such as shortening the lifespan of a chip or occurrence of defects may occur due to external moisture penetration or plating solution penetration during a plating process through an interface joint between the body and the side margin portion.

Accordingly, research is actively conducted to prevent moisture reliability degradation in ultra-small and high-capacitance products.

### SUMMARY

An aspect of the present disclosure is to provide a multilayer electronic component having improved moisture resistance by supplementing an interface structure between a body and side margin portions to prevent external moisture penetration.

An aspect of the present disclosure is to provide an ultrasmall multilayer electronic component by forming an external electrode to be thin and uniform.

However, the aspects of the present disclosure are not limited to the above-described contents, and may be more easily understood in the process of describing specific embodiments of the present disclosure.

A multilayer electronic component may include: a body including a capacitance formation portion including a dielectric layer and internal electrodes alternately arranged with the dielectric layer in a first direction and cover portions disposed on both end-surfaces of the capacitance formation portion in the first direction, and including first and second surfaces opposing each other in the first direction, third and fourth surfaces connected to the first and second surfaces and opposing each other in the second direction, and fifth and sixth surfaces connected to the first to fourth surfaces and opposing each other in the third direction; external electrodes disposed on the third and fourth surfaces; and side margin portions disposed on the fifth and sixth surfaces, and the side margin portion may include a first extension portion disposed to extend to portions of the first and second surfaces, and wherein at least a partial region of the first extension portion has a curvature, and when an average thickness of the side margin portion is WM0 and a radius of curvature of at least a portion of the first extension portion is R, WM0 and R may satisfy 1.1<R/WM0<2.

A multilayer electronic component according to some example embodiments may include: a body including a capacitance formation portion including a dielectric layer and internal electrodes alternately arranged with the dielectric layer in a first direction and cover portions disposed on both end-surfaces of the capacitance formation portion in the first direction, and including first and second surfaces opposing each other in the first direction, third and fourth surfaces connected to the first and second surfaces and opposing each other in the second direction, and fifth and sixth surfaces connected to the first to fourth surfaces and opposing each other in the third direction; external electrodes disposed on the third and fourth surfaces; and side margin portions disposed on the fifth and sixth surfaces, and the side margin portion may include a first extension portion disposed to extend to portions of the first and second surfaces, and wherein at least a partial region of the first extension portion has a curvature, and the external electrode may include a first electrode layer disposed to cover the first extension portion, and an average thickness of the first electrode layer is 1 μm or more and 8 μm or less.

A multilayer electronic component according to some example embodiments may include: a body including a capacitance formation portion including a dielectric layer and internal electrodes alternately arranged with the dielectric layer in a first direction and cover portions disposed on both end-surfaces of the capacitance formation portion in the first direction, and including first and second surfaces opposing each other in the first direction, third and fourth surfaces connected to the first and second surfaces and opposing each other in the second direction, and fifth and sixth surfaces connected to the first to fourth surfaces and opposing each other in the third direction; external electrodes disposed on the third and fourth surfaces; and side margin portions disposed on the fifth and sixth surfaces, and the side margin portion may include a first extension portion disposed to extend to portions of the first and second surfaces, and wherein at least a partial region of the first extension portion has a curvature, and the external electrode may include a first electrode layer disposed to cover the first extension portion, and an average thickness of the first electrode layer is 1 μm or more and 8 μm or less.

One of the various effects of the present disclosure may be to improve moisture resistance of a multilayer electronic component by supplementing an interface structure between a body and side margin portions to prevent external moisture penetration.

One of various effects of the present disclosure may be to miniaturize a multilayer electronic component by forming an external electrode to be thin and uniform.

However, the various and beneficial advantages and effects are not limited to the above-described contents, and may be more easily understood in the process of describing specific embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a stack-type electronic component according to an example embodiment of the present disclosure;

FIG. 2 schematically illustrates a perspective view excluding an external electrode from the multilayer electronic component of FIG. 1;

FIG. 3 schematically illustrates a perspective view excluding an external electrode and a side margin portion in the multilayer electronic component of FIG. 1;

FIG. 4 is a schematic cross-sectional view taken along line I-I′ of FIG. 1;

FIG. 5 is a schematic plan view of FIG. 2 (viewed from an upper portion in a first direction);

FIG. 6 is a side view (viewed from the left side in a second direction) of FIG. 2;

FIG. 7 is a schematic cross-sectional view taken along line II-II′ of FIG. 1;

FIG. 8 is an enlarged view of region M of FIG. 7;

FIG. 9A illustrates the thickness of each region of a first electrode layer of Comparative Example as a color palette and illustrates the percentage of each thickness in a histogram, and FIG. 9B illustrates the thickness of each region of a first electrode layer of Inventive Example as a color palette and illustrates the percentage of each thickness in a histogram; and

FIG. 10A is a graph illustrating an evaluation of moisture resistance of Comparative Example, and FIG. 10B is a graph illustrating an evaluation of moisture resistance of Inventive Example.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. The example embodiments disclosed herein are provided for those skilled in the art to better explain the present disclosure. Therefore, in the drawings, the shapes and dimensions of elements may be exaggerated for clarity, and the same reference numerals will be used throughout to designate the same or like elements.

In addition, in order to clearly describe the present disclosure in the drawings, the contents unrelated to the description are omitted, and since sizes and thicknesses of each component illustrated in the drawings are arbitrarily illustrated for convenience of description, the present disclosure is not limited thereto. In addition, components with the same function within the same range of ideas are described using the same reference numerals. Throughout the specification, when a certain portion “includes” or “comprises” a certain component, this indicates that other components are not excluded and may be further included unless otherwise noted.

In the drawings, a first direction may be a thickness T direction, a second direction may be a length L direction, and a third direction may be a width W direction.

### Multilayer Electronic Component

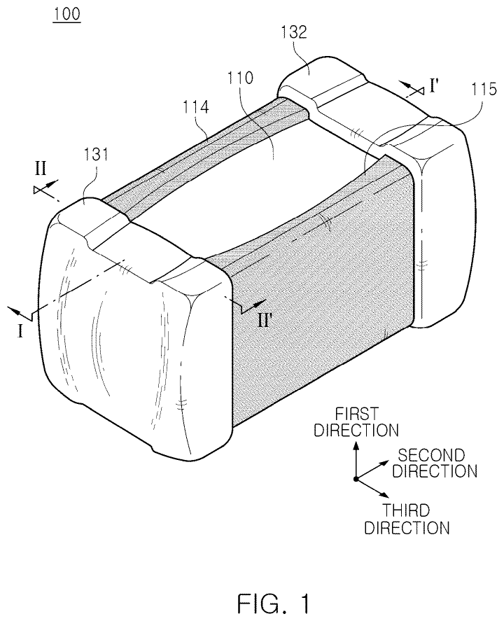

FIG. 1 is a perspective view schematically illustrating a stack-type electronic component according to an example embodiment of the present disclosure.

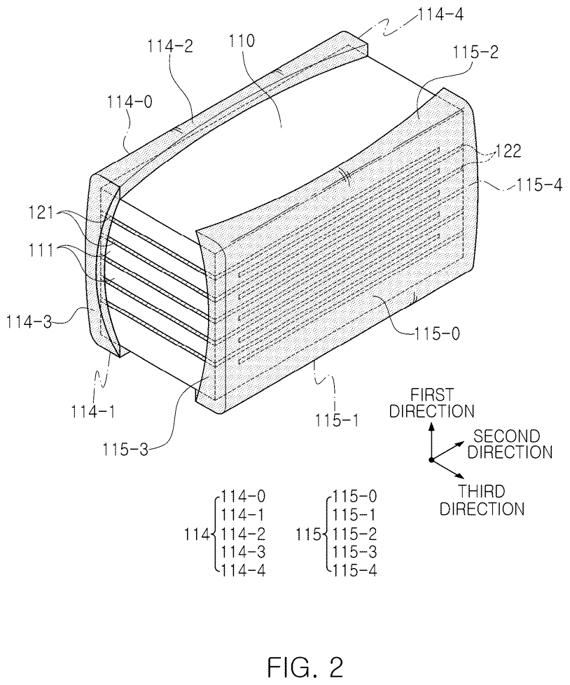

FIG. 2 schematically illustrates a perspective view excluding an external electrode from the multilayer electronic component of FIG. 1.

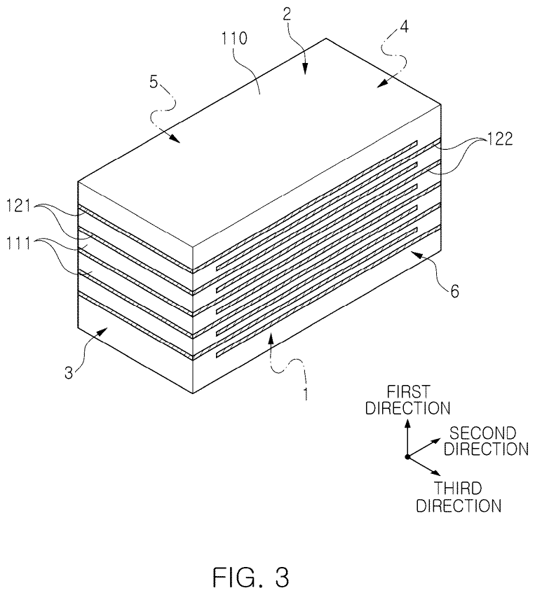

FIG. 3 schematically illustrates a perspective view excluding an external electrode and a side margin portion in the multilayer electronic component of FIG. 1.

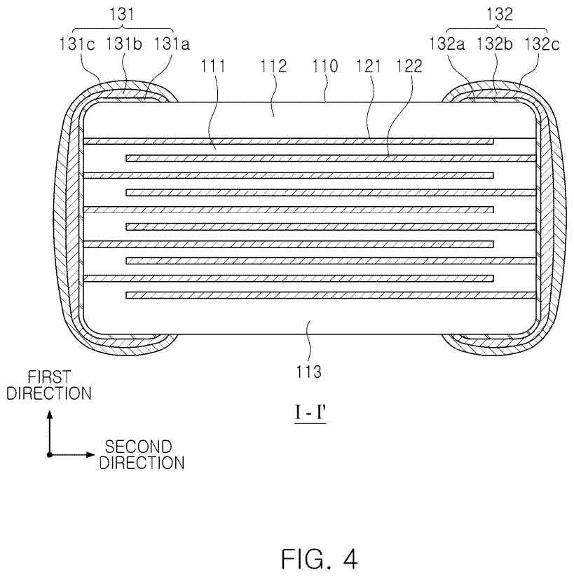

FIG. 4 is a schematic cross-sectional view taken along line I-I′ of FIG. 1.

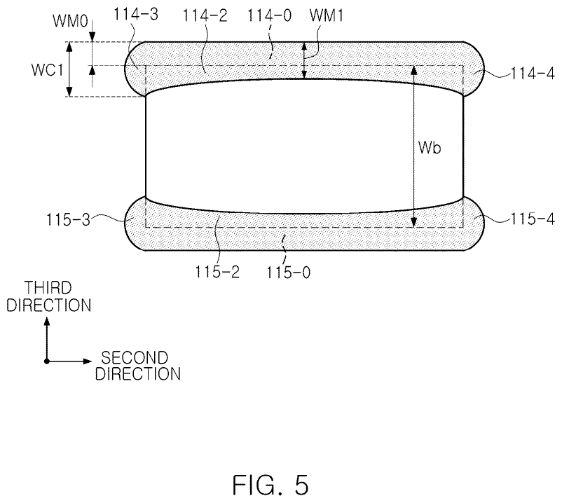

FIG. 5 is a schematic plan view of FIG. 2 (viewed from an upper portion in a first direction).

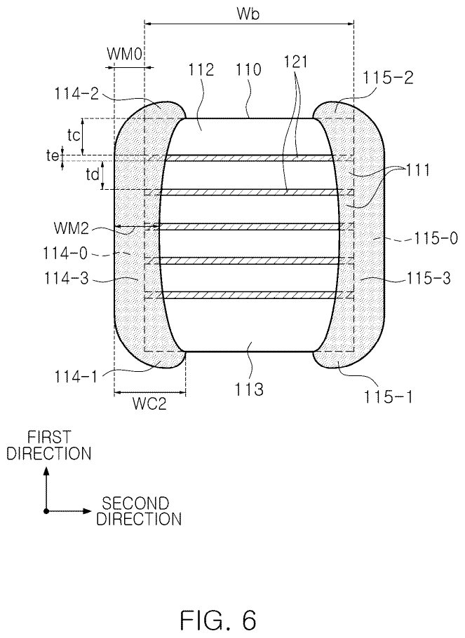

FIG. 6 is a side view (viewed from the left side in a second direction) of FIG. 2.

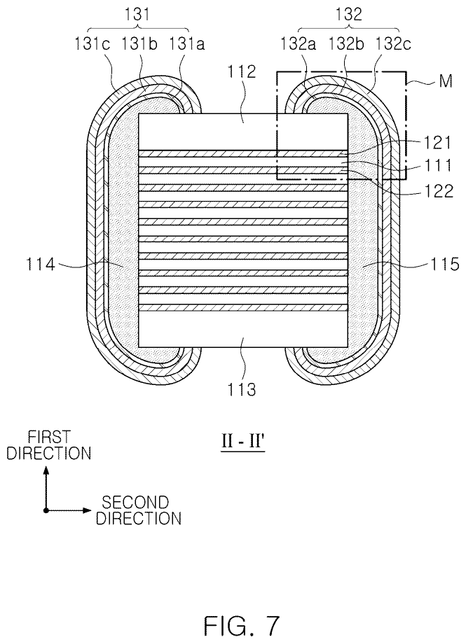

FIG. 7 is a schematic cross-sectional view taken along line II-II′ of FIG. 1.

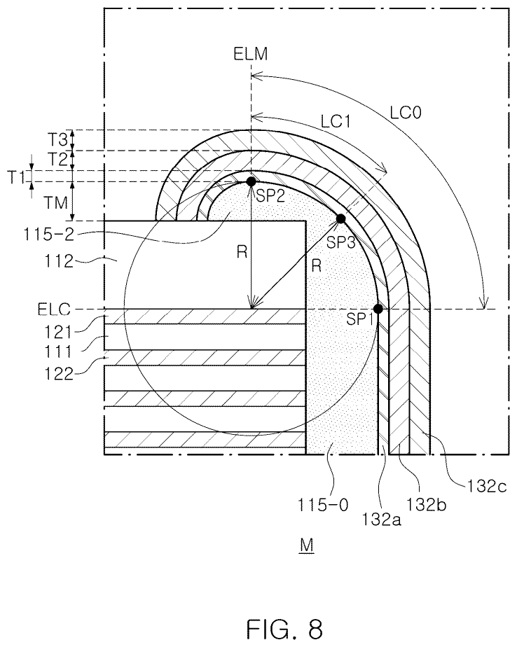

FIG. 8 is an enlarged view of region M of FIG. 7.

Hereinafter, a multilayer electronic component according to some example embodiments of the present disclosure will be described in detail with reference to FIGS. 1 to 8. However, as an example of a multilayer electronic component, a multilayer ceramic capacitor will be described, but the multilayer electronic component of the present disclosure may also be applied to various electronic products using dielectric compositions, such as inductors, piezoelectric elements, varistors, or thermistors.

According to some example embodiments of the present disclosure, a multilayer electronic component 100 may include: a body 110 including a capacitance formation portion Ac including a dielectric layer 111 and internal electrodes 121 and 122 alternately arranged with the dielectric layer 111 in a first direction, and cover portions 112 and 113 disposed on both end-surfaces of the capacitance formation portion Ac in the first direction, and including first and second surfaces 1 and 2 opposing each other in the first direction, third and fourth surfaces 3 and 4 connected to the first and second surfaces 1 and 2 and opposing each other in a second direction, and fifth and sixth surfaces 5 and 6 connected to the first to fourth surfaces 1, 2, 3 and 4 and opposing each other in a third direction; external electrodes 131 and 132 disposed on the third and fourth surfaces 3 and 4; and side margin portions 114 and 115 disposed on the fifth and sixth surfaces 5 and 6; and the side margin portions 114 and 115 may include first extension portions 114-1, 114-2, 115-1 and 115-2 which is disposed to extend to portions of the first and second surfaces 1 and 2, and wherein at least a partial region of the first extension portion has a curvature, and when an average thickness of the side margin portions 114 and 115 is WM0 and a radius of curvature of at least portions of the first extension portions 114-1, 114-2, 115-1 and 115-2 is R, WM0 and R may satisfy 1.1<R/WM0<2.

In the body 110, the dielectric layer 111 and the internal electrodes 121 and 122 may be alternately stacked.

More specifically, the body 110 may include a capacitance formation portion Ac disposed inside the body 110 and including first internal electrodes 121 and second internal electrodes 122 alternately disposed to face each other with the dielectric layer 111 interposed therebetween to form capacitance.

There is no particular limitation on the specific shape of the body 110, but as illustrated, the body 110 may have a hexahedral shape or a shape similar thereto. Due to contraction of ceramic powder particles included in the body 110 during a sintering process, the body 110 may not have a hexahedral shape with entirely straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3 and 4 and opposing each other in the third direction.

In a state in which a plurality of dielectric layers 111 included in the body 110 are sintered, boundaries between adjacent dielectric layers 111 may be integrated so as to be difficult to identify without using a scanning electron microscope (SEM).

The material forming the dielectric layer 111 is not limited as long as sufficient electrostatic capacity may be obtained. In general, a perovskite (ABO₃)-based material may be used, for example, a barium titanate-based material, a lead composite perovskite-based material, or a strontium titanate-based material may be used. The barium titanate-based material may include BaTiO₃-based ceramic particles, and examples of ceramic particles include BaTiO₃, and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1), which is formed by partially employing calcium (Ca) and zirconium (Zr) in BaTiO₃.

Additionally, as the materials included in the dielectric layer 111, various ceramic additives, organic solvents, binders, dispersants, and the like, may be added to particles such as barium titanate (BaTiO₃) according to the purpose of the present disclosure.

A thickness td of the dielectric layer 111 does not need to be particularly limited.

In order to secure reliability of the multilayer electronic component 100 under a high voltage environment, the thickness td of the dielectric layer 111 may be 10.0 μm or less. Additionally, in order to implement miniaturization and achieve high capacitance of the multilayer electronic component 100, the thickness td of the dielectric layer 111 may be 3.0 μm or less, and in order to more easily achieve ultra-miniaturization and high capacitance, the thickness td of the dielectric layer 111 may be 1.0 μm or less, and may preferably be 0.6 μm or less, and more preferably may be 0.4 μm or less.

In this case, the thickness td of the dielectric layer 111 may be a concept including a thickness of at least one of the plurality of dielectric layers, or may be a concept including a thickness of all dielectric layers.

Here, the thickness td of the dielectric layer 111 may denote the thickness td of the dielectric layer 111 disposed between the first and second internal electrodes 121 and 122.

Meanwhile, the thickness td of the dielectric layer 111 may denote a first directional size of the dielectric layer 111. Additionally, the thickness td of the dielectric layer 111 may denote an average thickness td of the dielectric layer 111, and may denote an average size of the dielectric layer 111 in the first direction.

The average size of the dielectric layer 111 in the first direction may be measured by scanning an image of the first and second directional cross-sections of the body 110 with a scanning electron microscope (SEM) at 10,000× magnification. More specifically, the average size of one dielectric layer 111 in the first direction may refer to an average value calculated by measuring the first directional size at 10 points equally spaced apart from each other in the second direction of one dielectric layer 111 in a scanned image. The 10 points equally spaced apart from each other may be designated in the capacitance formation portion Ac. Additionally, when the average value is measured by extending an average value measurement up to 10 dielectric layers 111, an average thickness of the dielectric layers 111 in the first direction may be further generalized.

The internal electrodes 121 and 122 may be alternately stacked with the dielectric layer 111. The internal electrodes 121 and 122 may include a first internal electrode 121 and a second internal electrode 122, and the first and second internal electrodes 121 and 122 may be alternately disposed to face each other with the dielectric layer 111 included in the body 110 interposed therebetween, and may be exposed to the third and fourth surfaces 3 and 4 of the body 110, respectively.

More specifically, the first internal electrode 121 may be spaced apart from the fourth surface 4 and may be exposed through the third surface 3, and the second internal electrode 122 may be spaced apart from the third surface 3 and may be exposed through the fourth surface 4. The first external electrode 131 may be disposed on the third surface 3 of the body 110 and may be connected to the first internal electrode 121, and the second external electrode 132 may be disposed on the fourth surface 4 of the body 110 and may be connected to the second internal electrode 122.

That is, the first internal electrode 121 may be connected to the first external electrode 131 without being connected to the second external electrode 132, and the second internal electrode 122 may be connected to the second external electrode 132 without being connected to the first external electrode 131. In this case, the first and second internal electrodes 121 and 122 may be electrically isolated from each other by a dielectric layer 111 disposed therebetween.

Meanwhile, the body 110 may be formed by alternately stacking a first ceramic green sheet on which a first internal electrode paste is printed and a second ceramic green sheet on which a second internal electrode paste is printed, and then sintering the first and second ceramic green sheets.

The material forming the internal electrodes 121 and 122 is not particularly limited, and a material having excellent electrical conductivity may be used for forming the internal electrodes 121 and 122. For example, the internal electrodes 121 and 122 may include one or more selected from the group consisting of nickel (Ni), copper (Cu), palladium (Pd), silver (Ag), gold (Au), platinum (Pt), tin (Sn), tungsten (W), titanium (Ti), and alloys thereof.

Additionally, the internal electrodes 121 and 122 may be formed by printing a conductive paste for internal electrodes including at least one selected from the group consisting of nickel (Ni), copper (Cu), palladium (Pd), silver (Ag), gold (Au), platinum (Pt), tin (Sn), tungsten (W), titanium (Ti), and alloys thereof on a ceramic green sheet. As a printing method of the conductive paste for internal electrodes, a screen-printing method, a gravure printing method, or the like, may be used, and the present disclosure is not limited thereto.

Meanwhile, a thickness te of the internal electrodes 121 and 122 does not need to be specifically limited.

In order to secure reliability under a high-voltage environment of the multilayer electronic component 100, the thickness te of the internal electrodes 121 and 122 may be 3.0 μm or less. Additionally, in order to implement miniaturization and achieve high capacitance of the multilayer electronic component 100, the thickness te of the internal electrodes 121 and 122 may be 1.0 μm or less, and in order to more easily achieve ultra-miniaturization and high capacitance, the thickness te of the internal electrodes 121 and 122 may be 0.6 μm or less, and more preferably, 0.4 μm or less.

In this case, the thickness te of the internal electrodes 121 and 122 may be a concept including the thickness te of at least one of the plurality of internal electrodes 121 and 122, or may be a concept including the thickness te of all the internal electrodes 121 and 122.

Here, the thickness te of the internal electrodes 121 and 122 may refer to a first directional size of the internal electrodes 121 and 122. Additionally, the thickness te of the internal electrodes 121 and 122 may refer to an average thickness te of the internal electrodes 121 and 122, and may refer to an average size of the internal electrodes 121 and 122 in the first direction.

The average size of the internal electrodes 121 and 122 in the first direction may be measured by scanning the image of the first and second directional cross-sections of the body 110 with a scanning electron microscope (SEM) at 10,000× magnification. More specifically, the average size of one internal electrode in the first direction may be an average value calculated by measuring the first directional size of one internal electrode at 10 points equally spaced apart from each other in the second direction in the scanned image. The 10 points equally spaced apart from each other may be designated in the capacitance formation portion Ac. Additionally, when the average value is measured by extending an average value measurement up to 10 internal electrodes 121 and 122, an average thickness of the internal electrodes in the first directional may be further generalized.

Meanwhile, in some example embodiments of the present disclosure, the thickness td of at least one of the plurality of dielectric layers 111 and the thickness te of at least one of the plurality of internal electrodes 121 and 122 may satisfy 2×te<td.

In other words, the thickness td of one of the dielectric layers 111 may be greater than twice the thickness te of one of the internal electrodes 121 and 122. Preferably, the average thickness td of the plurality of dielectric layers 111 may be greater than twice the average thickness te of the plurality of internal electrodes 121 and 122.

Generally, the reliability problem due to the decrease in the breakdown voltage (BDV) under a high-voltage environment is a major issue for high-voltage electrical electronic components.

Accordingly, in order to prevent a decrease in the breakdown voltage under a high voltage environment, the average thickness td of the dielectric layer 111 may be greater than twice the average thickness te of the internal electrodes 121 and 122, thereby increasing the thickness of the dielectric layer, which is a distance between the internal electrodes, and improving the breakdown voltage characteristics.

When the average thickness td of the dielectric layer 111 is less than twice the average thickness te of the internal electrodes 121 and 122, since the average thickness of the dielectric layer, which is the distance between the internal electrodes, is thin, the breakdown voltage may be decreased, and a short circuit may occur between the internal electrodes.

Meanwhile, the body 110 may include cover portions 112 and 113 disposed on both end-surfaces in the first direction of the capacitance formation portion Ac.

Specifically, the body 110 may include a first cover portion 112 disposed on one surface of the capacitance formation portion Ac in the first direction and a second cover portion 113 disposed on the other side of the capacitance formation portion Ac in the first direction, and more specifically, the body 110 may include an upper cover portion 112 disposed on an upper portion of the first direction of the capacitance formation portion Ac and a lower cover portion 113 disposed on a lower portion of the first direction of the capacitance formation portion Ac.

The first cover portion 112 and the second cover portion 113 may be formed by disposing or stacking a single dielectric layer or two or more dielectric layers on the upper and lower surfaces of the capacitance formation portion Ac in the first direction, respectively, and may basically play a role in preventing damage to the internal electrodes 121 and 122 due to physical or chemical stress.

The first cover portion 112 and the second cover portion 113 may not include the internal electrodes 121 and 122, and may include the same dielectric material as the dielectric layer 111 of the capacitance formation portion Ac. That is, the first cover portion 112 and the second cover portion 113 may include a ceramic material, for example, a barium titanate (BaTiO₃)-based ceramic material.

Meanwhile, a thickness tc of the cover portions 112 and 113 does not need to be particularly limited, and hereinafter, the description of the thickness tc of the cover portions 112 and 113 may refer to the thickness tc of each of the first cover portion 112 and the second cover portion 113.

However, in order to more easily implement miniaturization and achieve high capacitance of the multilayer electronic component, the thickness tc of the cover portions 112 and 113 may be 100 μm or less, preferably 30 μm or less, and more preferably 20 μm or less for ultra-small products. A lower limit of the thickness tc of the cover portions 112 and 113 may be 1 μm or more, and may be, preferably, 5 μm or more.

Here, the thickness tc of the cover portions 112 and 113 may refer to a first directional size of one cover portions 112 and 113.

Additionally, the thickness tc of the cover portions 112 and 113 may refer to an average thickness tc of the cover portions 112 and 113, and may refer to an average size of the cover portions 112 and 113 in the first direction.

An average size of the cover portions 112 and 113 in the first direction may be measured by scanning the image of the first and second directional cross-sections of the body 110 with a scanning electron microscope (SEM) at 10,000× magnification. More specifically, the average size may refer to an average value calculated by measuring the first directional size at 10 points equally spaced apart from each other in the second direction in an image obtained by scanning one cover portion.

Additionally, an average size of the cover portion in the first direction measured by the above-described method may have substantially the same size as the average size of the cover portion in the first direction in the first and third directional cross-sections of the body 110.

Meanwhile, the multilayer electronic component 100 may include side margin portions 114 and 115 disposed on both end-surfaces of the third direction of the body 110.

More specifically, the side margin portions 114 and 115 may include a first side margin portion 114 disposed on the fifth surface 5 of the body 110 and a second side margin portion 115 disposed on the sixth surface 6 of the body 110.

As illustrated, the side margin portions 114 and 115 may refer to a region between a third directional end-surfaces of the first and second internal electrodes 121 and 122 and a boundary surface of the body 110 based on the first and third-directional cross-sections of the body 110.

The side margin portions 114 and 115 have the internal electrodes 121 and 122 formed and stacked therein by applying a conductive paste to a region except for a region in which the side margin portions 114 and 115 are to be formed on the ceramic green sheet applied to the capacitance formation portion Ac. In this case, in order to suppress a step portion by the internal electrodes 121 and 122, the stacked internal electrodes 121 and 122 may be cut to be exposed to the fifth and sixth surfaces 5 and 6 of the body 110, and then, the side margin portions 114 and 115 may be formed by disposing or stacking a single dielectric layer or two or more dielectric layers in the third direction on the third directional end-surface of the capacitance formation portion Ac.

The side margin portions 114 and 115 may basically play a role in preventing damage to the internal electrodes 121 and 122 due to physical or chemical stress.

The first side margin portion 114 and the second side margin portion 115 may not include the internal electrodes 121 and 122 and may include the same dielectric material as the dielectric layer 111 of the capacitance formation portion Ac. That is, the first side margin portion 114 and the second side margin portion 115 may include a ceramic material, for example, a barium titanate (BaTiO₃)-based ceramic material.

Meanwhile, a thickness of the side margin portions 114 and 115 does not need to be specifically limited, but hereinafter, the description of the thicknesses of the side margin portions 114 and 115 may refer to thicknesses of each of the first side margin portion 114 and the second side margin portion 115.

However, in order to more easily implement miniaturization and achieve high capacitance of the multilayer electronic component 100, the thickness of the side margin portions 114 and 115 may be 50 μm or less, preferably 30 μm or less, and more preferably 20 μm or less in ultra-small products. A lower limit of the thickness of the side margin portions 114 and 115 may be 1 μm or more, preferably 5 μm or more.

Here, the thickness of the side margin portions 114 and 115 may be a concept including a (average) thickness WM0 or a third directional (average) size WM0 of each of main side margin portions 114-0 and 115-0 disposed on the fifth and sixth surfaces 5 and 6, but is not particularly limited thereto, and may be a concept including a first directional (average) size of each of the first extension portions 114-1, 114-2, 115-1 and 115-2 of the side margin portion described below and a second directional (average) size of each of the second extension portions 114-3, 114-4, 115-3 and 115-4 of the side margin portion described below. A detailed description of each region of the side margin portions 114 and 115 will be described below.

Additionally, the thicknesses of the side margin portions 114 and 115 may refer to an average thickness of the side margin portions 114 and 115.

For example, an average size of the main side margin portions 114-0 and 115-0 in the third direction disposed on the fifth and sixth surfaces 5 and 6 may be measured by scanning an image of the first and third-directional cross-sections of the body 110 with a scanning electron microscope (SEM) at 10,000× magnification. More specifically, the average size may refer to an average value calculated by measuring a third-directional size at 10 points equally spaced apart from each other in the first direction in an image obtained by scanning one side margin portion.

Meanwhile, in order to implement miniaturization and increase the capacitance of the multilayer ceramic capacitor, maximization of an electrode effective area (an increase in an effective volume fraction required for capacity implementation) is required. In order to implement a small-sized and high-capacitance multilayer ceramic capacitor, when manufacturing a multilayer ceramic capacitor, the internal electrode may be manufactured to be exposed in a width direction of the body, thereby maximizing a width directional area of the internal electrode through a marginless design. In this case, a method of separately attaching a ceramic green sheet for a side margin portion to an exposure surface of the internal electrode in a width direction and then sintering the ceramic green sheet to block exposure to the outside is applied.

The capacitance per unit volume of the capacitor may be improved by forming the side margin portion by separately attaching a ceramic green sheet for the side margin portion, but problems such as shortening the lifespan of the chip or causing defects may occur due to external moisture penetration or plating solution penetration during the plating process through an interface joint between the body and the side margin portion.

In the present disclosure, the side margin portion may be further extended and formed than the conventional side margin portion so as to cover the body and may be disposed on the body, so that an penetration path of external moisture or plating solution which may infiltrate through the interface joint formed at a boundary between the body and the side margin portion may be blocked or moved away, thus solving the aforementioned problems.

Accordingly, in the multilayer electronic component 100 according to some example embodiments of the present disclosure, the first and second side margin portions 114 and 115 may include main side margin portions 114-0 and 115-0 disposed on the fifth and sixth surfaces 5 and 6, respectively, and first extension portions 114-1, 114-2, 115-1 and 115-2 disposed to extend to portions of the first and second surfaces 1 and 2.

That is, the first side margin portion 114 may include a first main side margin portion 114-0 disposed on the fifth surface 5 and first extension portions 114-1 and 114-2 disposed on portions of the first and second surfaces 1 and 2, respectively. Specifically, the first extension portion 114-1 and 114-2 of the first side margin portion may include a first-first extension portion 114-1 disposed on a portion of the first surface 1 and a first-second extension portion 114-2 disposed on a portion of the second surface 2.

The second side margin portion 115 may include a second main side margin portion 115-0 disposed on the sixth surface 6 and first extension portions 115-1 and 115-2 disposed on portions of the first and second surfaces 1 and 2, respectively. Specifically, the first extension portions 115-1 and 115-2 of the second side margin portion may include a first-first extension portion 115-1 disposed on a portion of the first surface 1 and a first-second extension portion 115-2 disposed on a portion of the second surface 2.

Unless otherwise specified in the present disclosure, the description of the first extension portions 114-1, 114-2, 115-1 and 115-2 of the side margin portion may be equally applied to the first extension portions 114-1 and 114-2 of the first side margin portion and the first extension portions 115-1 and 115-2 of the second side margin portion. Additionally, the description of the first extension portions 114-1 and 114-2 of the first side margin portion may be equally applied to the first-first extension portion 114-1 disposed on a portion of the first surface 1 and the first-second extension portion 114-2 disposed on a portion of the second surface 2. Similarly, the description of the first extension portions 115-1 and 115-2 of the second side margin portion may be equally applied to the first-first extension portion 115-1 disposed on a portion of the first surface 1 and the first-second extension portion 115-2 disposed on a portion of the second surface 2.

The first and second side margin portions 114 and 115 may include the first extension portions 114-1, 114-2, 115-1 and 115-2 disposed to extend to portions of the first and second surfaces 1 and 2 of the body, so that the penetration of external moisture or plating solution may be effectively prevented, thereby improving moisture resistance reliability.

At least partial regions of the first extension portions 114-1, 114-2, 115-1 and 115-2 may have a curvature, that is, may include a curved region.

In this case, when the average thickness of the side margin portions 114 and 115 is WM0, and a radius of curvature of at least partial regions of the first extension portions 114-1, 114-2, 115-1 and 115-2 is R, WM0 and R may satisfy 1.1<R/WM0<2.

Here, the average thickness WM0 of the side margin portions 114 and 115 may be the average thickness WM0 of each of the first main side margin portions 114-0 and the second main side margin portions 115-0, and a radius of curvature R of at least partial regions of the first extension portions 114-1, 114-2, 115-1 and 115-2 may refer to a radius of curvature R of partial regions of one of the first extension portions 114-1, 114-2, 115-1 and 115-2.

More specifically, for example, a ratio (R/WM0) of the radius of curvature R of at least a portion of the first-second extension portion 115-2 of the second side margin portion to the average thickness WM0 of the second main side margin portion 115-0 may satisfy 1.1<R/WM0<2.

When WM0 and R satisfy 1.1<R/WM0<2, an interface between the body 110 and the side margin portions 114 and 115 may be sufficiently covered, thereby preventing moisture penetration from the outside, and improving moisture resistance reliability.

When WM0 and R are R/WM0≤1.1, the moisture resistance reliability may not be sufficiently improved, and it may be difficult for WM0 and R to be 2≤R/WM0 in the design of the side margin portions 114 and 115, and even if 2≤R/WM0 is satisfied, it may be difficult to implement miniaturization of the multilayer electronic component 100.

In some embodiments, the average thickness WM0 of the side margin portions 114 and 115 may satisfy 5 μm≤WM0≤30 μm.

For the convenience of measurement, the average thickness WM0 of the side margin portions 114 and 115 may be, for example, an average size WM0 of each of the main side margin portions 114-0 and 115-0 in the third direction disposed on the fifth and sixth surfaces 5 and 6, but the present disclosure is not particularly limited thereto.

When WM0<5 μm is satisfied, there may be a concern that the internal electrodes 121 and 122 may not be sufficiently protected. An upper limit value of WM0 is not particularly limited, but in order to implement the miniaturization of the multilayer electronic component 100, the upper limit value may be, preferably, WM0≤30 μm.

A method for measuring the radius of curvature R of at least partial regions of the first extension portions 114-1, 114-2, 115-1 and 115-2 may be, for example, as follows.

Referring to FIG. 8, first, the first and third directional cross-sections including the body 110 including the first cover portion 112, the first-second extension portion 115-2 of the second side margin portion, and the second external electrode 132, in the multilayer electronic component 100, are captured using a scanning electron microscope (SEM). In this case, in addition to the scanning electron microscope (SEM), a transmission electron microscope (TEM) or a scanning transmission electron microscope (STEM) may be used. In an image captured by a scanning electron microscope (SEM), a point SP1 in contact with the main side margin portion 115-0 of the second side margin portion furthest from the capacitance formation portion Ac is indicated based on an extension line ELC of the interface between the first cover portion 112 and the capacitance formation portion Ac. In some embodiments, the extension line ELC may be a line parallel to the third direction. Next, a point SP2 of the first-second extension portion 115-2 of the second side margin portion furthest from the capacitance formation portion Ac is indicated based on the first direction. Here, the point SP2 may be a maximum height point of the first-second extension portion 115-2 of the second side margin portion. Additionally, when a distance (including direction) measured along an outer line (surface) of the second side margin 115 from the point SP2 to the point SP1 is LC0, the distance (the same direction as LC0) to point ½ SP3 of LC0 may be LC1, and when an arbitrary circle including SP2 and SP3 is drawn, a virtual circle with a radius of curvature R may be obtained, and R in this case may be a radius of curvature of at least partial regions of the first extension portions 114-1, 114-2, 115-1 and 115-2.

Meanwhile, for the convenience of measuring the thickness of each of the first cover portion 112, the first-second extension portion 115-2 of the second side margin portion, a first electrode layer 132a of the second external electrode, a first plating layer 132b of the second external electrode, and a second plating layer 132c of the second external electrode, when the extension line ELM including SP2 is drawn from the capacitance formation portion Ac based on the first direction, the first directional size of each component may be interpreted as a thickness of each component.

More specifically, for example, the first directional size of the first cover portion 112 on the extension line ELM may be interpreted as a thickness tc of the first cover portion, the first directional size of the first-second extension portion 115-2 of the second side margin portion on the extension line ELM may be interpreted as a thickness TM of the first-second extension portion 115-2 of the second side margin portion, the first directional size of the first electrode layer 132a on the extension line ELM may be interpreted as a thickness T1 of the first electrode layer 132a, the first directional size of the first plating layer 132b on the extension line ELM may be interpreted as a thickness T2 of the first plating layer 132b, and the first directional size of the second plating layer 132c on the extension line ELM may be interpreted as a thickness T3 of the second plating layer 132c, but the present disclosure is not particularly limited thereto, and thicknesses of each component may be defined by a general or thickness measurement method described in the present disclosure.

The radius of curvature R of at least partial regions of the first extension portions 114-1, 114-2, 115-1 and 115-2 may satisfy 11 μm<R<20 μm.

When R satisfies 11 μm<R<20 μm, the interface between the body 110 and the side margin portions 114 and 115 may be sufficiently covered, thereby preventing external moisture penetration, and improving moisture resistance reliability.

When R is R≤11 μm, moisture resistance reliability may not be sufficiently improved, and it may be difficult for R to be 20 μm≤R in the design of the side margin portions 114 and 115, and even if 20 μm≤R is satisfied, it may be difficult to implement miniaturization of the multilayer electronic component 100.

Meanwhile, when a curvature value of at least partial regions of the first extension portions 114-1, 114-2, 115-1 and 115-2 is κ, κ may satisfy 50 nm⁻¹<κ<90 nm⁻¹. Here, the curvature κ may be an inverse number (κ=1/R) of the radius of curvature R.

By satisfying 50 nm⁻¹<κ<90 nm⁻¹, the interface between the body 110 and the side margin portions 114 and 115 may be sufficiently covered, thereby preventing external moisture penetration and improving moisture resistance reliability.

When κ≤50 nm⁻¹ is satisfied, the moisture resistance reliability may not be sufficiently improved, and it may be difficult for κ to be 90 nm⁻¹≤κ in the design of the side margin portions 114 and 115, and even if κ is 90 nm⁻¹≤κ, it may be difficult to implement miniaturization of the multilayer electronic component 100.

Hereinafter, the first extension portions 114-1, 114-2, 115-1 and 115-2 of the side margin portion will be described in detail.

When a third directional size in a second directional center of the first extension portions 114-1, 114-2, 115-1 and 115-2 is WM1, and a third directional size in a second direction end of the first extension portions 114-1, 114-2, 115-1 and 115-2 is d WC1, WM1≤WC1 may be satisfied.

Since the first extension portions 114-1, 114-2, 115-1 and 115-2 satisfies WM1≤WC1, interfacial adhesion between the body 110 and the side margin portions 114 and 115 may be excellent, and specifically moisture penetration in a corner portion of the body 110 in which external moisture penetration is easy, for example, an region in which the body 110, the side margin portions 114 and 115 and the external electrodes 131 and 132 meet, may be further suppressed, thereby further improving the moisture resistance reliability of the multilayer electronic component 100.

Regarding WM1 and WC1 of the first extension portions 114-1, 114-2, 115-1 and 115-2, the first-second extension portion 114-2 of the first side margin portion as is described an example and explained more specifically, as follows.

In the first-second extension portion 114-2 of the first side margin portion disposed on the second surface 2, when the first-second extension portion 114-2 of the first side margin is divided into three equal regions in the second direction, a central region of the three equal regions may correspond to a central portion of the first-second extension portion 114-2 of the first side margin portion, and the remaining regions on both sides may correspond to ends of the first-second extension portion 114-2 of the first side margin portion. In this case, a third directional size at one point in the second direction, among the central portion of the first-second extension portion 114-2 of the first side margin portion, may be WM1, and a third directional size at one point in the second direction, among the ends of the first-second extension portion 114-2 of the first side margin portion, may be WC1.

For a more preferable example, a third directional minimum size of the first-second extension portion 114-2 of the first side margin portion, among the central portion of the first-second extension portion 114-2 of the first side margin portion, may be WM1, and a third directional size of the first-second extension portion 114-2 of the first side margin portion disposed on an extension surface of the third surface 3, among the ends of the first-second extension portion 114-2 of the first side margin portion may be WC1, but the present disclosure is not particularly limited thereto, and a third directional size of the first-second extension portion 114-2 of the first side margin portion disposed on an extension surface of the fourth surface 4, among the ends of the first-second extension portion 114-2 of the first side margin portion, may also be WC1. In this description, the first-second extension portion 114-2 of the first side margin portion is described as an example, but the description thereof may be equally applied to the first-first extension portion 114-1 of the first side margin portion, and the first-first extension portion 115-1 and the first-second extension portion 115-2 of the second side margin portion, unless contradictory.

Additionally, in the multilayer electronic component 100 according to some example embodiments of the present disclosure, the first extension portions 114-1, 114-2, 115-1 and 115-2 of the first and second side margin portions may include a region having a substantially concave shape, and preferably, may be a region having a substantially concave shape.

Additionally, in the multilayer electronic component 100 according to some example embodiments of the present disclosure, the first extension portions 114-1, 114-2, 115-1 and 115-2 of the first and second side margin portions may include a region in which the third directional size of the first extension portions 114-1, 114-2, 115-1 and 115-2 of the first and second side margin portions increases from a second directional central portion of the first extension portions 114-1, 114-2, 115-1 and 115-2 of the first and second side margin portions to the second directional end of the first extension portions 114-1, 114-2, 115-1 and 115-2 of the first and second side margin portions, and may be, preferably, an increasing region.

The first extension portions 114-1, 114-2, 115-1 and 115-2 of the first and second side margin portions may include a substantially concave shape, or include a region in which the third directional size increases from the second directional central portion to the second directional end portion, so that interfacial bonding force between the body 110 and the side margin portions 114 and 115 may be excellent, and the moisture resistance reliability may be further improved.

Meanwhile, in the multilayer electronic component 100 according to some example embodiments of the present disclosure, the first and second side margin portions 114 and 115 may include second extension portions 114-3, 114-4, 115-3 and 115-4 disposed to extend to portions of the third and fourth surfaces 3 and 4.

That is, the first side margin portion 114 may include second extension portions 114-3 and 114-4 disposed on portions of the third and fourth surfaces 3 and 4. Specifically, the second extension portions 114-3 and 114-4 of the first side margin portion may include a second-first extension portion 114-3 disposed on a portion of the third surface 3, and a second-second extension portion 114-4 disposed on a portion of the fourth surface 4.

The second side margin portion 115 may include second extension portions 115-3 and 115-4 disposed on portions of the third and fourth surfaces 3 and 4. Specifically, the second extension portions 115-3 and 115-4 of the second side margin portion may include a second-first extension portion 115-3 disposed on a portion of the third surface 3, and a second-second extension portion 115-4 disposed on a portion of the fourth surface 4.

More specifically, the first side margin portion 114 may include a main portion 114-0 disposed on the fifth surface 5, a second-first extension portion 114-3 disposed to extend to a portion of the third surface 3, and a second-second extension portion 114-4 disposed to extend to a portion of the fourth surface 4. The second side margin portion 115 may include a main portion 115-0 disposed on the sixth surface 6, a second-first extension portion 115-3 disposed to extend to a portion of the third surface 3, and a second-second extension portion 115-4 disposed to extend to a portion of the fourth surface 4.

In the present disclosure, unless otherwise specified, the description of the second extension portions 114-3, 114-4, 115-3 and 115-4 of the side margin portion may be applied equally to the second extension portions 114-3 and 114-4 of the first side margin portion and the extension portions 115-3 and 115-4 of the second side margin portion. Additionally, the description of the second extension portions 114-3 and 114-4 of the first side margin portion may be equally applied to the second-first extension portion 114-3 disposed on a portion of the third surface 3 and the second-second extension portion 114-4 disposed on a portion of the fourth surface 4. Similarly, the description of the second extension portions 115-3 and 115-4 of the second side margin portion may be equally applied to the second-first extension portion 115-3 disposed on a portion of the third surface 3 and the second-second extension portion 115-4 disposed on a portion of the fourth surface 4.

Since the first and second side margin portions 114 and 115 include the second extension portions 114-3, 114-4, 115-3 and 115-4 disposed to extend to portions of the third and fourth surfaces 3 and 4 of the body, the moisture resistance reliability may be improved by effectively preventing the penetration of external moisture or plating solution.

At least partial regions of the second extension portions 114-3, 114-4, 115-3 and 115-4 may have a curvature, that is, may include a curved region.

In this case, when an average thickness of the side margin portions 114 and 115 is WM0, and a radius of curvature of at least partial regions of the second extension portions 114-3, 114-4, 115-3 and 115-4 is R′, WM0 and R′ may satisfy 1.1<R′/WM0<2.

By satisfying WM0 and R′ 1.1<R′/WM0<2, the interface between the body 110 and the side margin portions 114 and 115 may be sufficiently covered, so that moisture penetration from the outside may be prevented, thereby improving moisture resistance reliability.

If WM0 and R′ satisfy R′/WM0≤1.1, the moisture resistance reliability may not be sufficiently improved, and it may be difficult for WM0 and R′ to be 2≤R′/WM0 in the design of the side margin portions 114 and 115, and even if 2≤R′/WM0 is satisfied, it may be difficult to implement miniaturization of the multilayer electronic component 100.

Here, the average thickness WM0 of the side margin portions 114 and 115 is the same as described above, and therefore, redundant descriptions thereof will be omitted.

A method of measuring the radius of curvature R′ of at least partial regions of the second extension portions 114-3, 114-4, 115-3 and 115-4 may be the same as a method of measuring the radius of curvature R of at least partial regions of the first extension portions 114-1, 114-2, 115-1 and 115-2 described above, and may be obviously understood by those skilled in the art.

A radius of curvature R′ of at least partial regions of the second extension portions 114-3, 114-4, 115-3 and 115-4 may satisfy 11 μm<R′<20 μm.

By satisfying 11 μm<R′<20 μm, an interface between the body 110 and the side margin portions 114 and 115 may be sufficiently covered, thereby preventing external moisture penetration and improving moisture resistance reliability.

When R′≤11 μm is satisfied, the moisture resistance reliability may not be sufficiently improved, and it may be difficult for R′ to be 20 μm≤R in the design of the side margin portions 114 and 115, and even if 20 μm≤R′ is satisfied, it may be difficult to implement miniaturization of the multilayer electronic component 100.

Meanwhile, when a curvature value of at least partial regions of the second extension portions 114-3, 114-4, 115-3 and 115-4 is defined κ′, κ′ may satisfy 50 nm⁻¹<κ′<90 nm−1. Here, a curvature κ′ may be an inverse number (κ′=1/R′) of the radius of curvature R′.

By satisfying 50 nm⁻¹<κ′<90 nm⁻¹, an interface between the body 110 and the side margin portions 114 and 115 may be sufficiently covered, thereby preventing external moisture penetration and improving moisture resistance reliability.

When κ′≤50 nm⁻¹ is satisfied, the moisture resistance reliability may not be sufficiently improved, and it may be difficult for κ′ to be 90 nm⁻¹≤κ′ in the design of the side margin portions 114 and 115, and even if κ′ is 90 nm₋₁≤κ′, it may be difficult to implement miniaturization of the multilayer electronic component 100.

Hereinafter, the second extension portions 114-3, 114-4, 115-3 and 115-4 of the side margin portion will be described in detail.

When a third directional size in a first directional center of the second extension portions 114-3, 114-4, 115-3 and 115-4 is WM2, and a third directional size in a first directional end of the second extension portions 114-3, 114-4, 115-3 and 115-4 is WC2, WM2≤WC2 may be satisfied.

Since the second extension portions 114-3, 114-4, 115-3 and 115-4 satisfy WM2≤WC2, interfacial adhesion between the body 110 and the side margin portions 114 and 115 may be excellent, and specifically, moisture penetration in a corner portion of the body 110 in which external moisture penetration is easy, for example, in a region in which the body 110, the side margin portions 114 and 115 and the external electrodes 131 and 132 meet, may be further suppressed, thereby further improving the moisture resistance reliability of the multilayer electronic component 100.

When the second extension portions 114-3, 114-4, 115-3 and 115-4 is WC2<WM2, there may be a concern that external moisture penetration may be easily performed, which may reduce moisture resistance reliability.

For WM2 and WC2 of the second extension portions 114-3, 114-4, 115-3 and 115-4, the second-first extension portions 114-3 of the first side margin section may be more specifically described as an example, as follows.

In a second-first extension portion 114-3 of the first side margin portion disposed on the third surface 3, when the second-first extension portion 114-3 of the first side margin portion is divided into three equal regions in the first direction, a central region of the three equal regions may correspond to a central region of the second-first extension portion 114-3 of the first side margin portion, and the remaining upper and lower regions may correspond to ends of the second-first extension portion 114-3 of the first side margin portion. In this case, a third directional size at one point in the first direction, among the central regions of the second-first extension portion 114-3 of the first side margin portion may be WM2, and a third directional size at one point in the first direction, among the ends of the second-first extension portion 114-3 of the first side margin portion, may be WC2.

For a more preferable example, a third directional minimum size of the second-first extension portion 114-3 of the first side margin portion, among a central portion of the second-first extension portion 114-3 of the first side margin portion, may be WM2, and a third directional size of the second-first extension portion 114-3 of the first side margin portion disposed on an extension surface of the first surface 1, among ends of the second-first extension portion 114-3 of the first side margin portion, may be WC2, but the present disclosure is not particularly limited thereto, and a third directional size of the second-first extension portion 114-3 of the first side margin portion disposed on the extension surface of the second surface 2, among ends of the second-first extension portion 114-3 of the first side margin portion, may also be WC2. In this description, the second-first extension portion 114-3 of the first side margin portion is described as an example, but the description thereof may be equally applied to the second-second extension portion 114-4 of the first side margin portion, and the second-first extension 115-3 and the second-second extension 115-4 of the second side margin portion.

Additionally, in the multilayer electronic component 100 according to another example embodiments of the present disclosure, the second extension portions 114-3, 114-4, 115-3 and 115-4 of the first and second side margin portions may include a region having a substantially concave shape, and preferably, may be a region having a substantially concave shape.

Additionally, in the multilayer electronic component 100 according to some example embodiments of the present disclosure, the second extension portions 114-3, 114-4, 115-3 and 115-4 of the first and second side margin portions may include a region in which the third directional size of the second extension portions 114-3, 114-4, 115-3 and 115-4 of the first and second side margin portions increases from the first directional central portion of the second extension portions 114-3, 114-4, 115-3 and 115-4 of the first and second side margin portions to the first directional ends of the second extension portions 114-3, 114-4, 115-3 and 115-4 of the first and second side margin portions, and may preferably be an increasing region.

The second extension portions 114-3, 114-4, 115-3 and 115-4 of the first and second side margin portions may include a substantially concave shape, or may include a region in which the third directional size increases from the first directional central portion to the first directional end, so that interfacial bonding force between the body 110 and the side margin portions 114 and 115 may be excellent, and the moisture resistance reliability may be further improved.

The second extension portions 114-3, 114-4, 115-3 and 115-4 may be disposed to contact portions of the internal electrodes 121 and 122 exposed to one surface of the body 110.

More specifically, the second-first extension portion 114-3 of the first side margin portion may be disposed to contact one end of the first internal electrode 121 in the second direction exposed to the third surface 3, and the second-second extension portion 114-4 of the first side margin portion may be disposed to contact one end of the second internal electrode 122 in the second direction exposed to the fourth surface 4.

The second-first extension 115-3 of the second side margin portion may be disposed to contact the other end of the first internal electrode 121 in the second direction exposed to the third surface 3, and the second-second extension 115-4 of the second side margin portion may be disposed to contact the other end of the second internal electrode 122 in the second direction exposed to the fourth surface 4.

The second extension portions 114-3, 114-4, 115-3 and 115-4 may be disposed to contact portions of the first and second internal electrodes 121 and 122 exposed to the third and fourth surfaces 3 and 4 of the body 110, thereby more effectively preventing external moisture from penetrating into the interior and deteriorating the internal electrodes.

In another example embodiments of the present disclosure, the first and second side margin portions 114 and 115 may include first and second extension portions 114-1, 114-2, 114-3, 114-4, 115-1, 115-2, 115-3 and 115-4 at the same time, and more specifically, the first side margin portion 114 may include first extension portions 114-1 and 114-2 and second extension portions 114-3 and 114-4 at the same time, and the second side margin portion 115 may include first extension portions 115-1 and 115-2 and the second extension portions 115-3 and 115-4 at the same time. The description thereof is the same as described above and thus, redundant descriptions thereof will be omitted.

In some example embodiments of the present disclosure, a multilayer electronic component 100 is described as having a structure having two external electrodes 131 and 132, but the number or shape of the external electrodes 131 and 132 may be changed depending on the shape of the internal electrodes 121 and 122 or other purposes.

The external electrodes 131 and 132 may be disposed on the body 110 and may be connected to the internal electrodes 121 and 122.

More specifically, the external electrodes 131 and 132 may be disposed on the third and fourth surfaces 3 and 4 of the body 110, respectively, and may include first and second external electrodes 131 and 132 connected to the first and second internal electrodes 121 and 122, respectively. That is, the first external electrode 131 may be disposed on the third surface 3 of the body and may be connected to the first internal electrode 121, and the second external electrode 132 may be disposed on the fourth surface 4 of the body and may be connected to the second internal electrode 122.

Additionally, the external electrodes 131 and 132 may be disposed to extend to portions of the first and second surfaces 1 and 2 of the body 110, or may be disposed to extend to portions of the fifth and sixth surfaces 5 and 6 of the body 110. That is, the first external electrode 131 may be disposed on portions of the first, second, fifth and sixth surfaces 1, 2, 5 and 6 of the body 110 and on the third surface 3 of the body 110, and the second external electrode 132 may be disposed on portion of the first, second, fifth and sixth surfaces 1, 2, 5 and 6 of the body 110 and on the fourth surface 4 of the body 110.

The external electrodes 131 and 132 may be disposed to cover portions of the side margin portions 114 and 115.

For example, the first and second external electrodes 131 and 132 may be disposed on the third and fourth surfaces 3 and 4, respectively, and may be disposed to extend to portions of the first, second, fifth, and sixth surfaces 1, 2, 5 and 6. In this case, when the first and second side margin portions 114 and 115 are disposed on the fifth and sixth surfaces 5 and 6 respectively and are disposed to extend to portions of the first to fourth surfaces 1, 2, 3 and 4, the first and second external electrodes 131 and 132 may be disposed to cover the first and second side margin portions 114 and 115.

Meanwhile, the external electrodes 131 and 132 may be formed using any material having electrical conductivity, such as a metal, and a specific material may be determined by considering electrical characteristics, structural stability, and the like, and further, may have a multilayer structure.

For example, the external electrodes 131 and 132 may include an electrode layer disposed on the body 110 and a plating layer disposed on the electrode layer. In this case, the electrode layer may include a first electrode layer disposed on the body and a second electrode layer disposed on the first electrode layer, and the plating layer may include a first plating layer disposed on the electrode layer and a second plating layer disposed on the first plating layer, but the present disclosure is not particularly limited thereto. The contents of the electrode layer and the plating layer will be described in more detail below.

For a more specific example of the first electrode layers 131a and 132a, the first electrode layers 131a and 132a may be a sintered electrode layer including a first conductive metal and glass.

The first electrode layers 131a and 132a may be formed by transferring a sheet including the first conductive metal onto the body 110, or the first electrode layers 131a and 132a may be formed by applying a conductive paste prepared by adding glass frit to the first conductive metal to the body 110 and then sintering the conductive paste, or may be formed by dipping the body 110 into the paste including the first conductive metal, but the present disclosure not particularly limited thereto.

The first conductive metal included in the first electrode layers 131a and 132a is not particularly limited as long as the first conductive metal has a material that may be electrically connected to the internal electrodes 121 and 122 for forming a capacitance, and for example, may include at least one selected from the group consisting of nickel (Ni), copper (Cu), palladium (Pd), silver (Ag), gold (Au), platinum (Pt), tin (Sn), tungsten (W), titanium (Ti), and alloys thereof.

The first electrode layers 131a and 132a may serve to improve bonding with the body 110 by including glass.

In some example embodiments of the present disclosure, an average thickness of the first electrode layers 131a and 132a may be 1 μm or more and 8 μm or less.

When an average thickness of the first electrode layers 131a and 132a is 1 μm or more and 8 μm or less, the electrical connectivity may be excellent while implementing the miniaturization of the multilayer electronic component 100.

When the average thickness of the first electrode layers 131a and 132a is less than 1 μm, the electrical connectivity may not be sufficient, and when the average thickness of the first electrode layers 131a and 132a exceeds 8 μm, it may be difficult to implement the miniaturization of the multilayer electronic component 100.

In this case, in the first electrode layers 131a and 132a, a region having a thickness of less than 1 μm may be less than 8%, and may be, preferably, 5% or less, more, preferably 2% or less.

When the region of the first electrode layers 131a and 132a having a thickness of less than 1 μm is less than 8%, it may be possible to implement miniaturization of the multilayer electronic component 100 while achieving excellent electrical connectivity.

When the region of the first electrode layers 131a and 132a having a thickness of less than 1 μm is 8% or more, the first electrode layers 131a and 132a may not have sufficient electrical connectivity, and short circuit defects may occur.

Additionally, a region of the first electrode layers 131a and 132a having a thickness of 1 μm or more and 5 μm or less may be 80% or more, preferably 85% or more, and more preferably 90% or more.

When a region of the first electrode layers 131a and 132a having a thickness of 1 μm or more and 5 μm or less is 80% or more, it may be possible to implement miniaturization of the multilayer electronic component 100 while achieving excellent electrical connectivity.

When a region in which a thickness of the first electrode layers 131a and 132a is 1 μm or more and 5 μm or less is less than 80%, there may be a concern that the electrical connectivity may not be sufficient or a short circuit defect may occur, and it may be difficult to implement the multilayer electronic component 100.

The method for measuring the position-dependent thickness of the first electrode layer (131a, 132) may be as follows, but is not limited thereto. First, a cross-sectional image in the first and third directions that includes the external electrode is captured using a scanning electron microscope (SEM), and the first electrode layer is selected. In this step, the first electrode layer may be chosen from the region between the distinguishable second electrode layer and the body (side margin portion). Next, the thickness of the selected first electrode layer is measured in increments of 0.5 μm using a thickness measurement program embedded in the SEM, and the measured values are then displayed in a bar graph or the like to determine the position-dependent thickness of the first electrode layer (131a, 132a).

In the present disclosure, by adopting a shape in which the side margin portions 114 and 115 are arranged to extend to some portions of the first to fourth surfaces, that is, a structure including the first extension portions 114-1, 114-2, 115-1 and 115-2 or the second extension portions 114-3, 114-4, 115-3 and 115-4, the first electrode layers 131a and 132a may be formed thinly and uniformly.

Accordingly, when forming a paste for the external electrode on the body, the paste for the external electrode may form a vortex by the first and second extension portions of the side margin portion, so that a flow of an edge portion of the body may be suppressed, and an external electrode in which a thickness thereof is thin and uniform. On the other hand, in the case of an edge portion region of the body having almost no curvature (when the radius of curvature is relatively small) in the conventional side margin portion structure without the first and second extension portions, the flow of the paste for the external electrode may be fast, and thus, since the formation of the thickness of the external electrode is insignificant, the external electrode may barely be formed, and the external electrode may be formed to be thick due to surface tension in in the central portion of the body in which the flow is relatively slow. Additionally, in the case of the edge portion region of the body having a curve (when the radius of curvature is relatively large) in the conventional side margin portion structure without the first and second extension portions, since the flow of the paste for the external electrode is slow, the thickness of the external electrode may be formed thinly, but may not be formed uniformly.

Additionally, in some example embodiments of the present disclosure, the average thickness of the first electrode layers 131a and 132a may be thinner than an average thickness of the plating layers 131b, 132b, 131c and 132c described below.

Since the average thickness of the first electrode layers 131a and 132a is thinner than the average thickness of the plating layers 131b, 132b, 131c and 132c, it may be possible to implement miniaturization of the multilayer electronic component 100 while maintaining excellent electrical connectivity.

When the average thickness of the first electrode layers 131a and 132a is thicker than the average thickness of the plating layers 131b, 132b, 131c and 132c, it may be difficult to implement the miniaturization of the multilayer electronic component 100.

In the present disclosure, a method for measuring a thickness or an average thickness of the external electrodes 131 and 132 may be described, for example, as follows, and even if the external electrodes 131 and 132 are formed of a multilayer structure, the thickness or the average thickness of each layer may be measured. Hereinafter, a method for measuring a thickness T1 or an average thickness of the first electrode layers 131a and 132a will be described, but the thickness or the average thickness of the second electrode layer or the plating layer described below may also be measured using the same method.

First, the first and third directional cross-sections including the first cover portion 112, the first-second extension portion 115-2 of the second side margin portion, and the second external electrode 132 of the multilayer electronic component 100 are captured using a scanning electron microscope (SEM). In this case, not only the scanning electron microscope (SEM), but also a transmission electron microscope (TEM) or a scanning transmission electron microscope (STEM) may be used. In the image captured by the scanning electron microscope (SEM), the first electrode layer 132a of the second external electrode covering the first cover portion 112 and the first-second extension portion 115-2 of the second side margin portion is observed and layer classification thereof is performed. In this case, when the second external electrode 132 is formed of a multilayer structure, boundary surfaces of each layer may be distinguished from each other, and when it is difficult to distinguish the boundary surfaces, energy dispersive X-ray spectroscopy (EDS) may be used to classify the layers according to the main component material included in each layer. Then, the shortest distance from an outer surface of the first-second extension portion 115-2 of the first cover portion 112 and the second side margin portion to the first electrode layer 132a of the second external electrode is measured at 3,000 points and quantified, in which case the shortest distance to the first electrode layer 132a of the second external electrode may refer to the thickness T1 of the first electrode layer 132a of the second external electrode. A method for measuring the shortest distance is not particularly limited, and any program that may measure distance may be used. Additionally, an average value of the shortest distances at the 3,000 points measured in this manner may correspond to an average thickness of the first electrode layer 132a of the second external electrode.

Although not illustrated in the drawing, the electrode layer may further include a second electrode layer, and the second electrode layer may be a conductive resin layer, which is a resin-based electrode including a second conductive metal and a resin.

The second electrode layer may be disposed on the first electrode layers 131a and 132a disposed on the body 110, but the present disclosure is not particularly limited thereto.

The second conductive metal included in the second electrode layer may serve to perform electrical connection to the first electrode layers 131a and 132a.

The second conductive metal included in the second electrode layer is not particularly limited as long as the second conductive metal has a material that may be electrically connected with the first electrode layers 131a and 132a, and may include one or more selected from the group consisting of nickel (Ni), copper (Cu), palladium (Pd), silver (Ag), gold (Au), platinum (Pt), tin (Sn), tungsten (W), titanium (Ti), and alloys thereof.

A conductive metal included in the first electrode layers 131a and 132a may be referred to as a first conductive metal, and a conductive metal included in the second electrode layer may be referred to as second conductive metal, and the first conductive metal and the second conductive metal may be identical to or different from each other. In the case of including a plurality of conductive metals, only some of the plurality of conductive metals may be included as the same conductive metal, but the present disclosure is not particularly limited.

The second electrode layer may serve to improve the bending strength by including the resin.

The second conductive metal included in the second electrode layer may include at least one of spherical particles and flake-shaped particles. That is, the second conductive metal may be formed of only flake-shaped particles, or may be formed of only spherical particles, or may be a mixed form of flake-shaped particles and spherical particles. Here, the spherical particles may also include a form that is not a perfect spherical shape, and, for example, may include a form in which a length ratio of a major axis to a minor axis (major axis/minor axis) is 1.45 or less. The flake-shaped particles refer to particles having a flat and elongated shape, and the present disclosure is not particularly limited, but for example, a ratio of a length of a major axis to a minor axis (major axis/minor axis) may be 1.95 or more. The length of the major axis and the minor axis of the spherical particles and the flake-shaped particles may be measured from an image obtained by scanning first and second directional cross-sections obtained by cutting a central portion of the multilayer electronic component in the third direction using a scanning electron microscope (SEM).

The resin included in the second electrode layer may serve to secure bonding properties and absorbing shocks. The resin included in the second electrode layer is not particularly limited as long as the resin has bonding properties and shock absorbing properties and may be mixed with the second conductive metal particles to make a paste, and may include, for example, an epoxy resin.

Additionally, the second electrode layer may include a plurality of second conductive metal particles, an intermetallic compound, and a resin. The intermetallic compound may be included to further improve the electrical connectivity to the first electrode layers 131a and 132a. The intermetallic compound may serve to improve the electrical connectivity by connecting a plurality of metal particles, and may perform a role of surrounding and connecting a plurality of metal particles.

In this case, the intermetallic compound may include a metal having a melting point lower than a curing temperature of the resin. That is, since the intermetallic compound includes a metal having a melting point lower than the curing temperature of the resin, a metal having a melting point lower than the curing temperature of the resin is melted during a drying and curing process, and an intermetallic compound is formed with some of the metal particles to surround the metal particles. In this case, the intermetallic compound may preferably include a low melting point metal of 300° C. or less.

For example, the intermetallic compound may include tin (Sn) having a melting point of 213 to 220° C. During the drying and curing process, Sn is melted, and the melted Sn wets high-melting-point metal particles such as silver (Ag), nickel (Ni), or copper (Cu) by capillary action, and reacts with some of silver (Ag), nickel (Ni), or copper (Cu) metal particles to form intermetallic compounds such as Ag₃Sn, Ni₃Sn₄, Cu₆Sn₅, and Cu₃Sn. Silver (Ag), nickel (Ni), or copper (Cu) that does not participate in the reaction remains in the form of metal particles.

Accordingly, the plurality of second conductive metal particles include one or more of Ag, Ni, and Cu, and the intermetallic compound may include one or more of Ag₃Sn, Ni₃Sn₄, Cu₆Sn₅, and Cu₃Sn.

The plating layer 131b, 132b, 131c and 132c may serve to improve the mounting characteristics. The type of the plating layer 131b, 132b, 131c and 132c is not particularly limited, and may include at least one of nickel (Ni), tin (Sn), silver (Ag), palladium (Pd) or alloys thereof.

For example, the plating layer 131b, 132b, 131c and 132c may be plating layers 131b and 132b as single layers, or may be formed of a plurality of plating layers 131b, 132b, 131c and 132c.

More specifically, the plating layers 131b, 132b, 131c and 132c may include first plating layers 131b and 132b disposed on the electrode layer and second plating layers 131c and 132c disposed on the first plating layers 131b and 132b.

For example, the first plating layers 131b and 132b may be a Ni plating layer including nickel (Ni), and the second plating layers 131c and 132c may be a Sn plating layer including tin (Sn). However, the present disclosure is not particularly limited thereto, and the first plating layers 131b and 132b may be a Sn plating layer including tin (Sn), and the second plating layers 131c and 132c may be a Ni plating layer including nickel (Ni).

A thickness of the first and second plating layers 131b, 132b, 131c and 132c is not particularly limited, but a thickness T2 of the first plating layers 131b and 132b may be 1 μm or more and 10 μm or less, and a thickness T3 of the second plating layers 131c and 132c may be 3 μm or more and 15 μm or less.

A size of the multilayer electronic component 100 does not need to be particularly limited. However, in order to implement the miniaturization and achieve the high capacitance at the same time, the thickness of the dielectric layer and the internal electrode should be reduced to increase the number of layers, so that the effect according to the present disclosure may be more remarkable in a multilayer electronic component 100 of size 3216 (length×width: 3.2 mm×1.6 mm), size 2012 (length×width: 2.0 mm×1.2 mm), size 1005 (length×width: 1.0 mm×0.5 mm), size 0603 (length×width: 0.6 mm×0.3 mm), size 0402 (length×width: 0.4 mm×0.2 mm), or size 0201 (length×width: 0.2 mm×0.1 mm) or less.

Hereinafter, the present disclosure will be described in more detail through examples, but this is to help a specific understanding of the present embodiments, and the scope of the present disclosure is not limited by the examples.

### TEST EXAMPLE

In Comparative Example 1 and Comparative Example 2, MLCC to which conventional side margin portions were attached was manufactured in a chip form. That is, the side margin portions of the comparative example correspond to a structure in which the side margin portions are disposed only on both end-surfaces (the fifth and sixth surfaces) of the body in the third direction, and are not disposed on at least one of both end-surfaces (the first to fourth surfaces) of the body in the first and second directions.

More specifically, Comparative Example 1 and Comparative Example 2 include a body including a capacitance formation portion including a dielectric layer and internal electrodes, and cover portions disposed on both end-surfaces of the capacitance formation portion in the first direction, and side margin portion disposed on both end-surfaces of the body in the third direction, and external electrodes including a first electrode layer, a first plating layer, and a second plating layer are disposed on the outside.

In Inventive Example 1 and Inventive Example 2, MLCC to which side margin portions were attached according to some example embodiments of the present disclosure was manufactured in a chip form. That is, the side margin portions of the inventive examples correspond to a structure disposed to extend to fifth and sixth surfaces of the body and extend from fifth and sixth surfaces to portions of the first to fourth surfaces, and the MLCC was manufactured in the same manner as the comparative example except for the structure of the side margin portion.

Hereinafter, radiuses of curvature and the curvatures of corners of the side margin portions of Comparative Example 1 and Inventive Example 1 were compared and measured, and the thicknesses of the first electrode layer Comparative Example 1 and Inventive Example 1 were compared.

First, the first and third directional cross-sections including the body including the first cover portion, the first-second extension portion of the second side margin portion, and the second external electrode in of Comparative Example 1 were captured using a scanning electron microscope (SEM). In this case, a point in contact with a main side margin portion of the second side margin portion, farthest from the capacitance formation portion based on the extension line of an interface between the first cover portion and the capacitance formation portion was indicated as SP1. Next, a point of the first-second extension portion of the second side margin portion, farthest from the capacitance formation portion, based on the first direction, was indicated as SP2. Additionally, a ½ point of a distance (including direction) measured along an outer line (surface) of the second side margin portion from the point SP2 to the point SP1 was indicated as SP3. Additionally, when an arbitrary circle including the points SP2 and SP3 was drawn and the radius of curvature R′ was measured, the radius of curvature R′ was 10 μm, and when expressed as curvature κ′, this was 100 nm⁻¹.

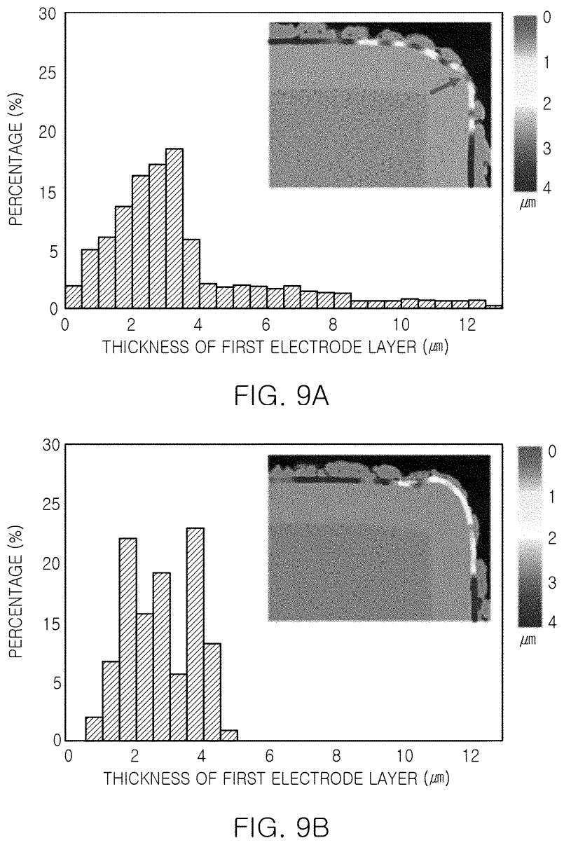

Additionally, the thickness of the first electrode layer observable in the captured image was measured, and FIG. 9A illustrates a thickness of a first electrode layer of Comparative Example 1 by region as a color palette and illustrates the percentage for each thickness as a histogram.

The thickness of the first electrode layer of Comparative Example 1 was measured to be greater than 0 μm and less than 13 μm, and a median value was calculated to be 3.49 μm and a standard deviation was calculated to be 2.45. Based thereon, it may be seen that the thickness of the first electrode layer of Comparative Example 1 is relatively thick but not uniform. Additionally, arrows in the image of FIG. 9A indicated a region in which the thickness of the first electrode layer disposed at a corner portion of the body is less than 1 μm, and the region of the first electrode layer less than 1 μm was measured to be 8%.

When the radius of curvature R of Inventive Example 1 was measured by the above-described method, the radius of curvature R was 15 μm, and when expressed as a curvature (κ), this was 66.7 nm⁻¹.

FIG. 9B illustrates the thickness of the first electrode layer of Inventive Example 1 by region as a color plate and illustrates the percentage for each thickness as a histogram.

The thickness of the first electrode layer of Inventive Example 1 was measured to be 1 μm or more and 5 μm or less, and a median value was 2.83 μm and a standard deviation was calculated to be 0.98. Based thereon, it may be seen that the thickness of the first electrode layer of Inventive Example 1 is relatively thin and uniform. Additionally, the region of the first electrode layer of less than 1 μm was measured to be 2%.

Based thereon, it may be seen that the side margin structure disposed on portions of the first to fourth surfaces of the body may form the thickness of the first electrode layer to be thin and uniform.

Next, the moisture reliability evaluation of Comparative Example 2 and Inventive Example 2 was performed.

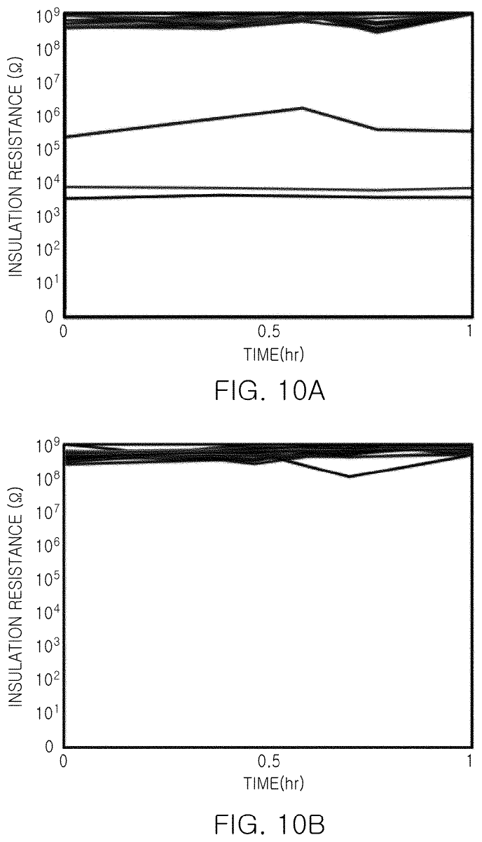

FIG. 10A is a graph illustrating the results of the moisture reliability evaluation of Comparative Example 2, and FIG. 10B is a graph illustrating the results of the moisture reliability evaluation of Inventive Example 2.

The moisture reliability evaluation was performed under the conditions of temperature conditions of 85° C., relative humidity of 85%, and voltage conditions of 1.2 Vr for 8 hours after manufacturing 40 sample chips of Comparative Example 2 and Inventive Example 2, respectively. Among the 40 sample chips, the sample chips in which an insulation resistance (IR) value decreased to 10⁶Ω or less were counted as defective.

In the case of Comparative Example 2, 3 out of 40 sample chips were defective, while in the case of Example 2, no chips were defective among the 40 sample chips.

Based thereon, it may be seen that the side margin structure disposed on portions of the first to fourth surfaces of the body has improved moisture reliability.

Although the example embodiments of the present disclosure has been described in detail above, the present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ used in the present disclosure does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the terms are merely used to describe a specific embodiment, and are not intended to limit the present disclosure. Singular forms may include plural forms as well unless the context clearly indicates otherwise.

What is claimed is:

1. A multilayer electronic component, comprising:
a body including a capacitance formation portion including a dielectric layer and internal electrodes alternately arranged with the dielectric layer in a first direction and cover portions disposed on both end-surfaces of the capacitance formation portion in the first direction, and including first and second surfaces opposing each other in the first direction, third and fourth surfaces connected to the first and second surfaces and opposing each other in the second direction, and fifth and sixth surfaces connected to the first to fourth surfaces and opposing each other in the third direction;
external electrodes disposed on the third and fourth surfaces; and
side margin portions disposed on the fifth and sixth surfaces,
wherein the side margin portion includes a first extension portion disposed to extend to portions of the first and second surfaces, and wherein at least a partial region of the first extension portion has a curvature, and
when an average thickness of the side margin portion is WM0 and a radius of curvature of at least a portion of the first extension portion is R,
WM0 and R satisfy 1.1<R/WM0<2.

2. The multilayer electronic component according to claim 1, wherein R satisfies 11 μm<R<20 μm.

3. The multilayer electronic component according to claim 1, wherein when a curvature value of the at least a partial region of the first extension portion is κ, κ satisfies 50 nm⁻¹<κ<90 nm⁻¹.

4. The multilayer electronic component according to claim 1, wherein WM0 satisfies 5 μm≤WM0≤30 μm.

5. The multilayer electronic component according to claim 1, wherein the external electrode includes a first electrode layer disposed to cover the first extension portion, and an average thickness of the first electrode layer is 1 μm or more and 8 μm or less.

6. The multilayer electronic component according to claim 5, wherein in the first electrode layer, a region having a thickness of less than 1 μm is less than 8% with respect to a total area of the first electrode layer.

7. The multilayer electronic component according to claim 5, wherein in the first electrode layer, a region having a thickness of 1 μm or more and 5 μm or less is 80% or more with respect to a total area of the first electrode layer.

8. The multilayer electronic component according to claim 1, wherein the external electrode includes a first electrode layer disposed to cover the first extension portion, and a plating layer disposed on the first electrode layer, and
an average thickness of the first electrode layer is thinner than an average thickness of the plating layer.

9. A multilayer electronic component, comprising:
a body including a capacitance formation portion including a dielectric layer and internal electrodes alternately arranged with the dielectric layer in a first direction and cover portions disposed on both end-surfaces of the capacitance formation portion in the first direction, and including first and second surfaces opposing each other in the first direction, third and fourth surfaces connected to the first and second surfaces and opposing each other in the second direction, and fifth and sixth surfaces connected to the first to fourth surfaces and opposing each other in the third direction;
external electrodes disposed on the third and fourth surfaces; and
side margin portions disposed on the fifth and sixth surfaces,
wherein the side margin portion includes a first extension portion disposed to extend to portions of the first and second surfaces, and wherein at least a partial region of the first extension portion has a curvature, and
the external electrode includes a first electrode layer disposed to cover the first extension portion, and an average thickness of the first electrode layer is 1 μm or more and 8 μm or less.

10. The multilayer electronic component according to claim 9, wherein when a radius of curvature of the at least a partial region of the first extension portion is R, R satisfies 11 μm<R<20 μm.

11. The multilayer electronic component according to claim 10, wherein when an average thickness of the side margin is WM0, WM0 and R satisfies 1.1<R/WM0<2.

12. The multilayer electronic component according to claim 9, wherein when a curvature value of the at least a partial region of the first extension portion is κ, κ satisfies 50 nm⁻¹<κ<90 nm⁻¹.

13. The multilayer electronic component according to claim 9, wherein when an average size of the side margin portions disposed on the fifth and sixth surfaces in the third direction is defined as WM0, the WM0 satisfies 5 μm≤WM0<30 μm.

14. The multilayer electronic component according to claim 9, wherein in the first electrode layer, a region having a thickness of less than 1 μm is less than 8%.

15. The multilayer electronic component according to claim 9, wherein in the first electrode layer, a region having a thickness of 1 μm or more and 5 μm or less is 80% or more.

16. The multilayer electronic component according to claim 9, wherein the external electrode further includes a plating layer disposed on the first electrode layer,
an average thickness of the first electrode layer is thinner than an average thickness of the plating layer.
